(19) United States
(12) Patent Application Publication
(10) Pub. No.: US 2008/0216964 A1
(43) Pub. Date: Sep. 11, 2008

(54) ADHESIVE TAPE APPLICATOR

(76) Inventor: Osamu Degawa, Osaka (JP)

Correspondence Address: Cheng Law Group, PLLC, 1100 17th Street, N.W., Suite 503, Washington, DC, 20036, US

(21) Appl. No.: 12/041,495

(22) Filed: Mar. 3, 2008

(30) Foreign Application Priority Data
Mar. 5, 2007 (JP) 2007-053986

(51) Int. Cl. B29C 65/00

(52) U.S. Cl. 156/538

(57) ABSTRACT

An Adhesive tape applicator is configured to sandwich a workpiece in a vertical direction with a plurality of guide rollers for engaging with the workpiece from above to roll around and a sandwiching guide roller for engaging with the workpiece from below. It has an application roller for applying an adhesive tape on a tape application face by elastically pressing the adhesive tape and a separation-prevention tape guide for preventing the adhesive tape from being separated from the application roller. A tape positioning part is also formed, which releases an upper end in a tape width direction of a tape insertion gap formed by the tape guide and receives and guides a lower side edge of the adhesive tape on a lower end of the tape insertion gap.

### BACKGROUND OF THE INVENTION

(1) Field of the Invention

The present invention relates to an adhesive tape applicator used when an adhesive tape is applied on a curved workpiece such as a door sash of an automobile.

(2) Description of the Related Art

In recent years, in a manufacturing process of an automobile, in place of black coating processing on an inside of a door sash (a workpiece), a technology to apply a black adhesive tape has been developed. In other words, an adhesive tape applicator (an adhesive tape application jig) has been suggested. Herein, an adhesive tape from which a separator has been separated is pressed against and applied on a tape application face of a side of a workpiece, while guiding and moving this adhesive tape applicator by hand along a workpiece (refer to JP-A 2001-328573 and JP-A 2005-35724).

The above-mentioned conventional adhesive tape applicator (the adhesive tape application jig) is mounted on the workpiece from above using a plurality of guide rollers to be engaged in a roll-around manner to an appropriate place in the back and front and right and left of the workpiece and this adhesive tape applicator is configured so as to apply an adhesive tape with an elastically deformable application roller while moving in a longitudinal direction of the workpiece by hand push.

However, its posture has been held by pressing the adhesive tape applicator against the workpiece from above.

Accordingly, when pressure against the workpiece weakens, the adhesive tape applicator floats or inclines vertically, so that the adhesive tape is displaced vertically for the workpiece. As a result, there is a risk that a crease is generated on the adhesive tape when applying the adhesive tape.

In order to solve such a defect, it is necessary to move the adhesive tape applicator by hand while always pressing the applicator firmly against the workpiece. Therefore, an operator cannot relax his or her concentration during the operation and this gives a stress to the operator, namely, making the operator to be mentally fatigued.

### SUMMARY OF THE INVENTION

A major object of the present invention is to provide an adhesive tape applicator, which enables to carry out the adhesive tape application operation lightly, smoothly, and continuously.

In order to achieve such an object, the present invention takes the following configuration. Namely, there is provided an adhesive tape applicator for applying an adhesive tape that is formed in a curved shape corresponding to curving of a tape application face on a workpiece having a tape application face oriented toward a lateral side curved along a face direction thereof, including: a guide roller for engaging with the workpiece from above so as to roll around, on a main body which is operated in moving along the workpiece, and a first sandwiching guide roller for engaging with the workpiece from below so as to sandwich the workpiece in a vertical direction in cooperation with the guide roller, wherein the main body is configured to be held in engagement at a predetermined posture with respect to the workpiece with both the guide roller and the first sandwiching guide roller; the applicator including a application roller for elastically pressing to apply an adhesive tape fed to the main body on a tape application face of the workpiece ; and a separation-prevention tape guide for preventing the adhesive tape from being separated from the application roller; wherein the applicator has a tape positioning part for releasing an upper end in a tape width direction of a tape insertion gap to be formed by the tape guide and for receiving and guiding a lower side edge of the adhesive tape on a lower end of the tape insertion gap.

According to the adhesive tape applicator of the present invention, the adhesive tape applicator that is mounted on the workpiece is sandwiched vertically by a group of guide rollers and a sandwiching guide roller so as to be stably held at a predetermined posture. Accordingly, even if a force to press the adhesive tape applicator against the workpiece from above weakens to some degree, the applicator neither floats nor inclines vertically with respect to the workpiece immediately. It is therefore possible to move forward the adhesive tape applicator with a predetermined posture maintained by firmly pressing it again.

In addition, even in the case that a curved portion of the workpiece is acutely angled, engagement by the sandwiching guide roller is modestly released just before passing the portion. However, the sandwiching guide roller is immediately engaged with a middle part of the curved portion so as to act as a supporting point. Accordingly, it is possible to stably guide and move the main body of the applicator along the workpiece with the sandwiching guide roller acting as a supporting point.

Further, it is preferable that the applicator is configured as follows.

For example, the first sandwiching roller is configured so as to be engaged with the outside face of the workpiece obliquely from a lower part of the workpiece.

According to this configuration, a positioning function is effected not only in a vertical direction but also in a lateral direction by sandwiching of the sandwiching roller in an oblique direction. As a result, the position of the adhesive tape applicator in a lateral direction is also stabilized.

In addition, it is preferable that the first sandwiching roller has a groove, formed on a rolling face, for placing and fastening an angular portion of the workpiece. According to this configuration, the applicator can reliably sandwich the workpiece in a vertical direction.

In addition, it is preferable that the applicator may include a spring for fixing a position of the guide roller and biasing the first sandwiching roller toward the side of the workpiece.

According to this configuration, the adhesive tape applicator is also biased in a lateral direction on the opposite side of a tape application face in a lateral direction component of the elastic pressing force given by the sandwiching guide roller. Accordingly, the lateral directional position of the adhesive roller opposed to the tape application face is stabilized and tape application can be continuously carried out without generation of unevenness of pressing in a workpiece longitudinal direction.

In addition, it is preferable that the applicator may include a second sandwiching roller rolling on the outside face of the workpiece opposite the tape application face.

According to this configuration, loading of the adhesive tape can be realized by the following operation before mounting the adhesive tape applicator on the workpiece.

By separating a separator from a front end of the adhesive tape, the tape application face is exposed. Winding this adhesive tape around the application roller and leading it backward, the adhesive tape is pulled out up to a rear part of the application roller. The backward front end of this adhesive tape is engaged with a tape fastening groove of a tape temporary application member. Accordingly, handling of the applicator is made easy since an application start end of the adhesive tape does not flip-flop during handling of the applicator till the adhesive tape is applied.

In addition, by engaging and mounting the adhesive tape applicator having the adhesive tape loaded on the workpiece, it is possible to apply the adhesive tape part guided to the application roller on the tape application face of the workpiece. In addition, by peeling off the tape end engaged with the tape temporary application member from the tape temporary application member after that and pressing it against the tape application face, application of a tape start end portion can be completed. Then, by moving forward the adhesive tape applicator along the workpiece, continuous tape application can be carried out.

In addition, in this configuration, it is preferable that the applicator may include a gage member for indicating an application start end to be opposed to an end portion of the adhesive tape that is temporarily fastened to the tape fastening groove on a rear part of the main body.

According to this configuration, the tape application position can be decided in the following procedures. The front end of the tape application tape engaged with the tape temporary application member has been fitted to a gage member in advance, the adhesive tape applicator is engaged and mounted on the workpiece so that the gage member is fitted to the tape applying start position of the workpiece, and the adhesive tape peeled off from the tape temporary application member is pressed against the tape application face. As mentioned above, applying of the adhesive tape from a desired position to the workpiece can be carried out.

In addition, it is preferable that the adhesive tape is provided with a separator; and

the adhesive tape applicator may include a separator guide for guiding the separator that is separated from the adhesive tape in a direction different from the adhesive tape, which is opposed in proximity to the application roller in a front position of the application roller.

According to this configuration, the separator separated upon applying the adhesive tape does not prevent a path in a moving direction of the applicator.

Further, it is preferable that the separator guide is configured as follows.

For example, the separator guide is raised and swung to be opposed in proximity to the application roller and is swingably configured so as to turn over perpendicular to a position for guiding the separator in a lateral outside.

Further, the applicator further may include a separator guide on the opposite ends of a separator guide base portion that is axially-supported on the lower face of the tape guide; wherein, when one separator guide swings the tape guide base portion around an axis so as to be opposed in proximity to the application roller on a front position in a progress direction, the separator guide located on a rear position of other application roller is configured so as to be separated from the application roller.

According to this configuration, by changing a direction of mounting the adhesive tape, the adhesive tape can be applied to the workpiece while moving the applicator in an inverse direction of the adhesive tape.

Further, it is preferable that the applicator may include a ball detent mechanism on a portion where the separator guide is opposed to the tape guide base portion.

According to this configuration, the separator guide can be fixed on a predetermined position.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 shows a side view showing that an adhesive tape applicator according to a first embodiment;

FIG. 2 shows a perspective view of the adhesive tape applicator according to the first embodiment;

FIG. 3 shows a front view of the adhesive tape applicator according to the first embodiment;

FIG. 4 shows a cross sectional plan view of the adhesive tape applicator according to the first embodiment;

FIG. 5 shows a side view of the adhesive tape applicator according to the first embodiment;

FIG. 6 shows a rear view of the adhesive tape applicator according to the first embodiment;

FIG. 7 shows a plan view of the adhesive tape applicator according to the first embodiment that is partially notched;

FIG. 8 shows a plan view across a part of an adhesive tape applicator according to a second embodiment that is partially cut across;

FIG. 9 shows a perspective view of an adhesive tape applicator according to a third embodiment;

FIG. 10 shows a front view of the adhesive tape applicator according to the third embodiment that is partially cutaway;

FIG. 11 shows a cross sectional plan view of the adhesive tape applicator according to the third embodiment;

FIG. 12 shows a side view of the adhesive tape applicator according to the third embodiment; and

FIG. 13 shows a side view of the adhesive tape applicator according to the third embodiment as seen from an inverse direction.

### DESCRIPTION OF THE PREFERRED EMBODIMENTS

Hereinafter, an embodiment of the present invention will be described below with reference to the drawings.

### First Embodiment

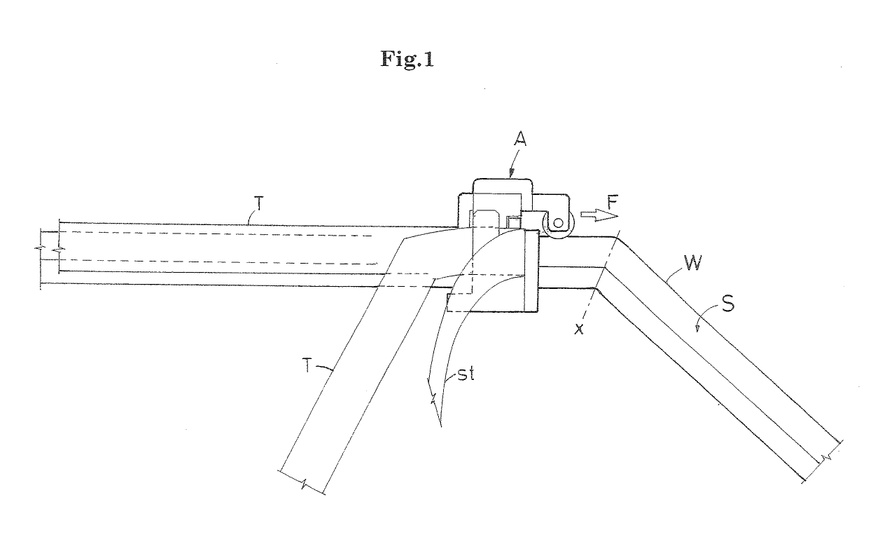

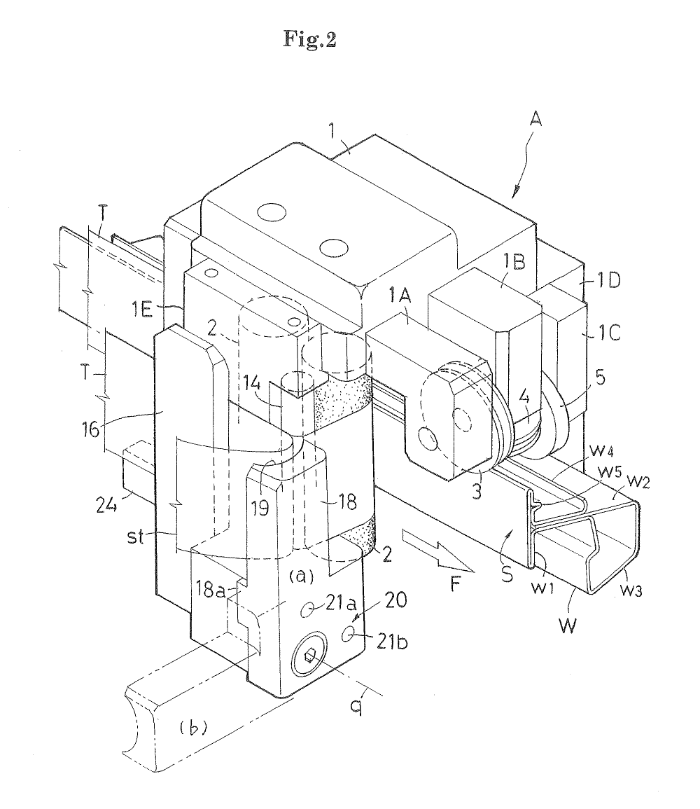

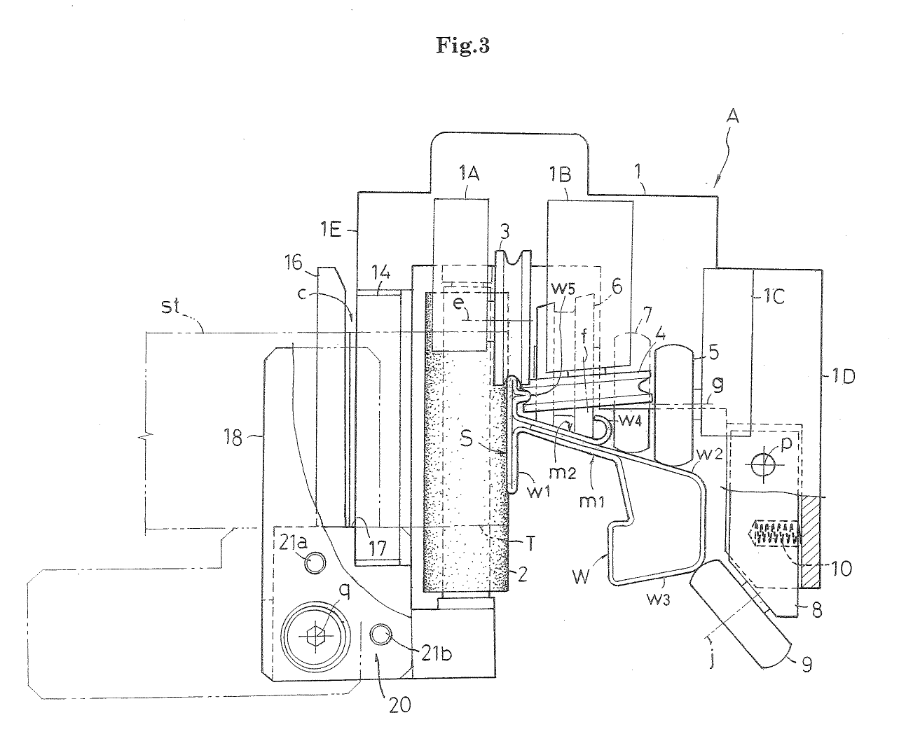

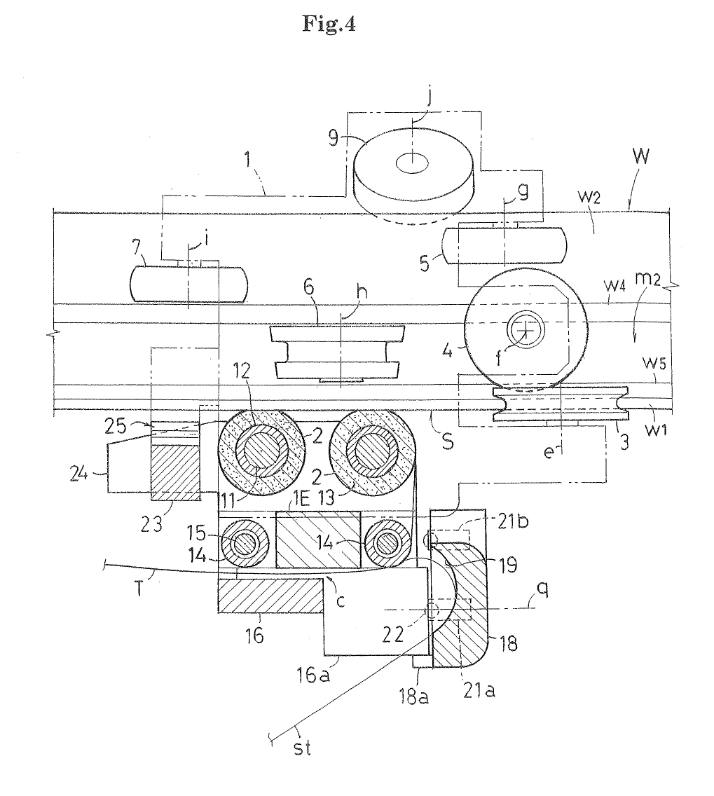

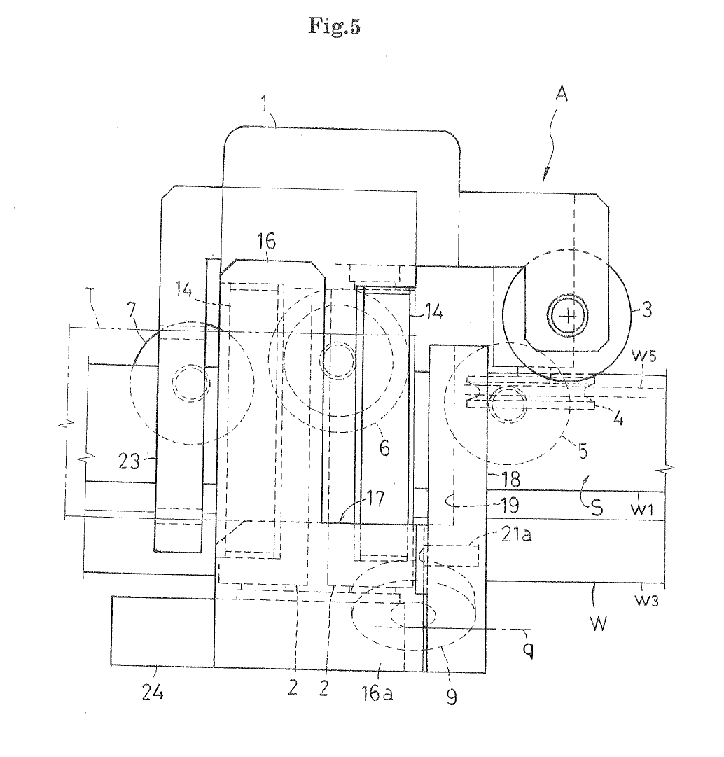

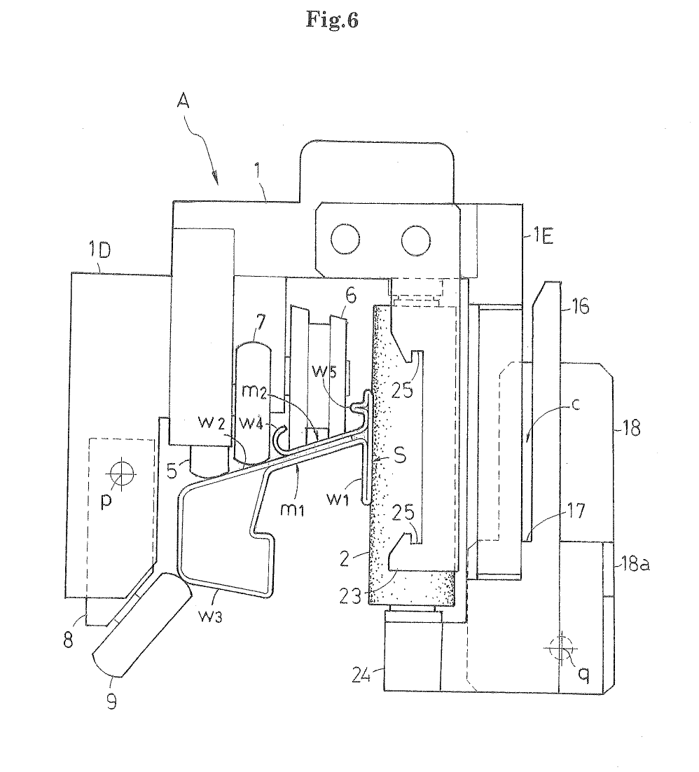

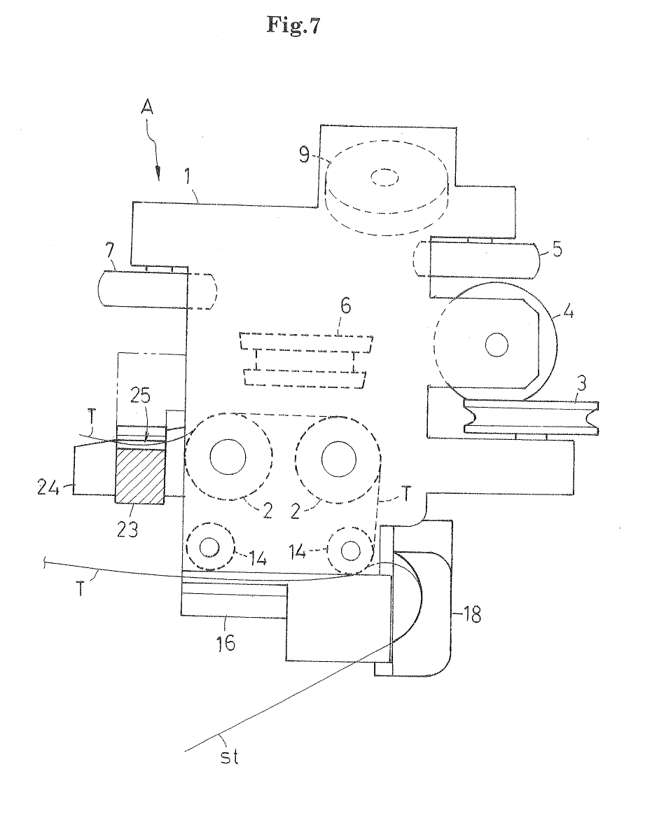

An adhesive tape applicator A according to a first embodiment is shown in FIGS. 1 to 7. Specifically, FIG. 1 is a side view showing the state that the adhesive tape applicator A according to the present invention is mounted on a workpiece W; FIG. 2 is a perspective view thereof; FIG. 3 is a front view thereof; FIG. 4 is a cross sectional plan view thereof; FIG. 5 is a side view thereof; FIG. 6 is a rear view thereof; and FIG. 7 is a plan view thereof.

Further, the workpiece W of this embodiment is a door sash of an automobile and is formed in a substantially trapezoidal shape being curved from back and forth of an upper side portion formed in a substantially linear shape toward a horizontal direction toward a lower part (in FIG. 1, only a part of a front half of the workpiece W is shown). The adhesive tape applicator A according to the present invention serves to apply a black adhesive tape T on a lateral side face of this workpiece W in place of black coating processing.

As shown in FIG. 2 and FIG. 3, the workpiece W is configured by press-polymerizing a sheet of a copper plate. Specifically, the workpiece W is formed in such a manner that a lateral frame portion w2 is thrown out from a vertical middle part of a longitudinal frame portion w1 in a longitudinal wall shape toward a lateral side (a right side in FIG. 3) with its front end inclined downward and the workpiece W has a sectional shape such that a hollow portion w3 is formed on the outer end portion of this lateral frame portion w2. Then, as shown in FIG. 3 and FIG. 4, a window glass mounting groove m1 is formed between the hollow portion w3 continued to the lower part of the outer end side of the lateral frame portion w2 and a lower half part of the longitudinal frame portion w1, and an upper-faced rib w4 is projected on a horizontal milled region of the upper face of the lateral frame portion w2 along a workpiece longitudinal direction. A curved lateral rib w5 is projected on the outer-faced side of the upper half part of the outer frame portion w1. Between the rib w4 and the rib w5, a weather strip mounting groove m2 is formed. Then, the lateral outside face in the outer frame portion w1 is made into a tape application face S that is curved along this face. On this tape application face S, the black adhesive tape T is applied by a manual work using the adhesive tape applicator A according to the present invention. Further, as the adhesive tape T, a tape broader than the width of a tape application face S with a separator is used. In addition, this adhesive tape T is punched and cut out in a curved shape fitted to curving of the tape adhesive applying face S.

The adhesive tape applicator A moves on hand along a workpiece longitudinal direction as being guided in engagement to the workpiece W so as to apply the adhesive tape T. As a result, in the following explanation, as a matter of convenience, a direction F for moving the adhesive tape applicator A for applying the tape is referred to as forward and an inner direction or an outer directions of a door being perpendicular to a tape applying direction F is referred to as a lateral direction or a vertical direction.

A main body 1 of the adhesive tape applicator A is formed by a block made of a hard resin material. On this main body 1, a member for applying a tape and a member for mounting the tape on the workpiece W are mounted as follows.

On the lower face near a lateral one end of the main body 1, a pair of back and forth application rollers 2 is mounted around a longitudinal axial core so as to be capable of idling, and as shown in FIGS. 2 to 4, on the front face of the main body 1, three support shaft portions 1A, 1B, and 1C are projected aligned in a lateral direction. On the side face of the support shaft portion 1A located in front of the application rollers 2, a first guide roller 3 formed by a grooved roller is mounted around a lateral axial core e so as to be capable of idling. On the lower face of the support shaft portion 1B located on a horizontally middle part, a second guide roller 4 formed by the grooved roller is mounted around a longitudinal axial core f that slightly inclines so as to be capable of idling. On the most outer side of the support shaft portion 1C, a third guide roller 5 of which outer circumference is convex-curved is mounted around a lateral axial core g so as to be capable of idling. Further, on a rear part of the second guide roller 4, the fourth guide roller 6 formed by a taper roller is arranged around a lateral axial core h so as to be capable of idling. Further, on a further rear place of this fourth guide roller 6, a fifth guide roller 7 of which outer circumference is convex-curved is mounted around a lateral axial core i so as to be capable of idling.

The support shaft portion 1D is elongated from the most outer place of the main body 1 toward a lower part, and as shown in FIG. 3, a movable bracket 8 that can swing around a support shaft p that is vertically directed is supported by this support shaft portion 1D. The lower end portion of this movable bracket 8 is obliquely cut, and on this oblique cut face, a sandwiching guide roller 9 of which outer circumference is convex-curved is mounted around a laterally inclined axial core j so as to be capable of idling.

Between the movable bracket 8 and the main body 1, a spring 10 that is deformed by pressure is put. This spring 10 biases the sandwiching guide roller 9 toward the side of the application rollers 2.

Further, the first guide roller 3 corresponds to the guide roller according to the present invention, the second guide roller 4 corresponds to a second sandwiching guide roller, and a sandwiching guide roller 9 corresponds to a first sandwiching guide roller, respectively.

These guide rollers 3 to 7 and the sandwiching guide roller 9 are formed by a hard resin material with an excellent lubricity. The first guide roller 3 is mounted and engaged with the upper end side of the longitudinal frame portion w1 of the workpiece W from above so as to be capable of rolling. The second guide roller 4 is engaged with the lateral rib w5 of the workpiece W from the lateral side so as to be capable of rolling. The third guide roller 5 is mounted and engaged with the upper face near the outer end of the lateral frame portion w2 of the workpiece W so as to be capable of rolling. The fourth guide roller 6 is mounted and engaged with a weather strip mounting groove m2 of the workpiece W so as to be capable of rolling. The fifth guide roller 7 is mounted and engaged with the upper face of the lateral frame portion w2 near the outside of the upper-faced rib w4 of the workpiece W so as to be capable of rolling. The sandwiching guide roller 9 having an inclined posture is engaged with an angular portion on the lower end of the outer end of the hollow portion w3 in the outer frame portion w2 of the workpiece W so as to be capable of rolling.

The first to fifth guide rollers 3 to 7 and the sandwiching guide roller 9 arranged dispersed vertically and horizontally are engaged with the workpiece W as described above, so that vertical and horizontal positions of the adhesive tape applicator A for the workpiece w and the posture of the adhesive tape applicator A in a workpiece longitudinal direction are stably held. Accordingly, the application rollers 2 are held in parallel with the tape application face S.

Here, the sandwiching guide roller 9 elastically presses the workpiece W obliquely upward, so that the workpiece W is elastically sandwiched from a vertical direction by the first guide roller 3, the third guide roller 5, the forth guide roller 6, and the fifth guide roller 7 to be engaged with the workpiece W from above and the sandwiching guide roller 9 to be engaged with the workpiece W from an oblique lower part. In this case, the tape applicator A is prevented from floating from the workpiece W. In addition, due to a lateral directional component of an elastic sandwiching force from the oblique direction of the sandwiching guide roller 9, the tape applicator A is also prevented from wobbling in a lateral direction for the workpiece W.

Further, even in the case that the curved portion of the workpiece is acutely angled, although engagement by the sandwiching guide roller 9 is modestly released just before passing the portion, the sandwiching guide roller is immediately engaged with a middle part of the curved portion so as to act as a supporting point. Accordingly, it is possible to stably swing and guide the main body of the applicator 1 along the workpiece supported by the sandwiching guide roller 9.

As shown in FIG. 4, the application rollers 2 are configured covering a tubular shaft 12 externally fitted and supported to and by a fixing core shaft 11 so as to be capable of idling with a sponge-type elastic layer 13. The tape applicator A is pressed in parallel being engaged with the workpiece W at predetermined position and posture while elastically deformed on the tape application face S of the workpiece W in moderation.

On the longitudinal support shaft portion 1E elongated downward from one end portion of the main body 1, a pair of horizontal tape feed rollers 14 is supported around a longitudinal axial core so as to be capable of idling being opposed to the application rollers 2 in parallel. This tape feed roller 14 is formed by a hard resin material with an excellent lubricity to be supported by a support shaft 15 that is mounted and fixed to the support shaft portion 1E so as to be freely fitted.

A platy tape guide 16 formed by a hard resin material is attached to the lower outside face of the support shaft portion 1E. As shown in FIG. 3 and FIG. 4, a tape insertion gap c released vertically and horizontally is formed between this tape guide 16 and the outside face of the support shaft portion 1E, and a bottom end of the tape insertion gap c is formed on a tape positing part 17. In other words, when the lower end edge of the adhesive tape T inserted through the tape insertion gap c is caught and supported by the tape positing part 17, positioning in a width direction of the adhesive tape T is carried out.

On the front end face of the tape guide 16, a separator guide 18 is attached. This separator guide 18 is arranged on a front position of the tape feed roller 14 on the front side opposed to the tape feed roller 14 with a small interval, and as shown in FIG. 2 and FIG. 4, on its rear face, a separator guide face 19 that is concave-curved opposed to the tape feed roller 14 is formed.

The separator guide 18 is pivotally mounted on the front face of the tape guide 16 so as to be capable of swinging around a support shaft q horizontally directed, and the separator guide 18 is raised and swung to be capable of being switched into a separator guide operation posture (a)opposed in proximity to the tape feed roller 14 and a release posture (b) that is largely separated from the tape feed roller 14 being turned over and swung perpendicular to a lateral outside.

On a region where the separator guide 18 is opposed to the front end of a tape guide base portion 16a, as a unit for stably holding the separator guide 18 at the separator guide operation posture (a) and the release posture (b), a ball detent mechanism 20 is provided. This ball detent mechanism 20 is formed by two sets of detent balls 21a and 22b mounted on the separate guide 18 with a phase of 90 degrees around the support shaft 1 and a single engagement concave portion 22 formed on the front end face of the tape guide base portion 16a as shown in FIG. 4. When the separator guide 18 takes the separator guide operation posture (a), one detent ball 21a is engaged with the engagement concave portion 22. When the separator guide 18 takes the release posture (b), another detent ball 21b is engaged with the engagement concave portion 22. Accordingly, the separator guide 18 is stably held at respective postures.

If a swinging operational force more than a holding force of the ball detent mechanism 20 is given to the separator guide 18 taking the separator guide operation posture (a) or the release posture (b), the detent balls 21a and 21b in an engagement state are stranded on the front end face of the tape guide 16 as elastically moving backward. After that, with a light operational force, the separator guide 18 can be swung. Accordingly, lead to a predetermined posture position, the detent balls 21a and 21b biased by a spring are engaged with the engagement concave portion 22 to be recessed and they are stably held at that posture.

When the separator guide 18 is raised and swung up to the separator guide operation posture (a), a project piece 18a continued to the lateral outside of the separator guide 18 abuts against the outside face of the tape guide base portion 16a and this makes positioning at the separator guide operation posture (a).

On the rear end portion of the main body 1, as shown in FIGS. 4 to 7, a tape temporary application member 23 is attached. In addition, a gage member 24 for starting applying of the tape is elongated backward from the rear end portion of the tape guide 16.

The tape temporary application member 23 serves to temporally support the adhesive tape T on the adhesive tape applicator A before being engaged and mounted on the workpiece W and the tape temporary application member 23 is arranged to be longer vertically near the rear parts of application rollers 2. On the side of the tape temporary application member 23 opposite the workpiece W, as shown in FIG. 6, a pair of vertical tape fastening grooves 25 is formed with an interval fitted to upper and lower widths of the adhesive tape. Accordingly, the tape fastening groove 25 winds the adhesive tape separated from a separator st around the application rollers 2 to be guided backward and by engaging the vicinity of the front end of the tape into the tape fastening groove 25, the tape end can be held. In addition, the adhesive tape T, of which upper and lower ends are engaged, can be peeled off from the tape fastening groove 25 to the side while flexing the adhesive tape T.

The front end of the gage member 24 is an index for indicating a applying start position. For example, by fitting the front end of the adhesive tape T held by the tape temporary application member 23 to the front end of the gage member 24 in advance and engaging and fitting the adhesive tape applicator A with the workpiece W with the front end of the gage member 24 fitted to a desired applying start position, applying of the tape can be carried out from a desired position.

The adhesive tape applicator A according to the present invention is configured as described above. Next, a step for applying the adhesive tape T to the workpiece W by using the applicator A of the above-described embodiment will be described.

At first, prior to the applying operation, the loading operation of the adhesive tape T to the adhesive tape applicator A is carried out. According to this tape loading operation, the adhesive tape T with the separator st is inserted through the tape insertion gap c at a longitudinal posture such that the separator st is located on a lateral outside. In the adhesive tape T that is peeled off from the tape insertion gap c forward, the separator st is separated from its front end and the tape application face is exposed.

Winding this adhesive tape T around the tape feed roller 14 and the application rollers 2, the adhesive tape T is guided backward.

In this case, by swinging the separator guide 18 in a lateral outside to be held at the release posture (b) and largely spacing the front part of the tape feed roller 14, the operation is made easy. Then, as shown in FIG. 7, with the backward front end portion of the adhesive tape T peeled off to rear parts of the application rollers 2 fitted to the front end of the gage member 24, the adhesive tape T is fastened to the tape fastening groove 25 of the tape temporary application member 23. In addition, by raising and swinging the separator guide 18, the separator guide 18 is returned to the separator guide operation posture (a)opposed in proximity to the tape feed roller 14. Thus, loading of the adhesive tape T to the adhesive tape applicator A has been completed.

In this way, the adhesive tape applicator A having the adhesive tape T loaded is engaged and mounted on the workpiece W by using the guide rollers 3 to 7 and the sandwiching guide roller 9. Due to this engagement, the tape portion to which the application rollers 2 are guided is pressed against the tape application face S of the workpiece W to be applied. In this case, fitting the front end of the gage member 24 to the tape applying start position on the tape application face S, peeling off the front end portion of the adhesive tape T fastened by the tape temporary application member 23 from the tape fastening groove 25, and pressing it against the tape application face S, the tape applying from a desires position can be made.

When loading of the adhesive tape applicator A on the workpiece W and the tape applying at the start end are completed, the adhesive tape applicator A is moved along the workpiece W on hand to a front part F. This makes it possible to continuously apply the adhesive tape T on the tape application face S while positioning the adhesive tape T in a width direction.

If the adhesive tape applicator A is moved to the front part F, the adhesive tape T is relatively moved to the front part F. In accordance with this movement, the separator st is reversibly guided on the separator guide face 19 of the separator guide 18 to be discharged in a direction separated from the application rollers 2. Accordingly, it is possible to prevent the separated separator st from being tangled by the adhesive tape T and approaching the tape application face S or being an obstacle of forward movement of the adhesive tape applicator A.

While moving the adhesive tape applicator A along the workpiece W to the front part F on hand, the workpiece W is elastically sandwiched in a vertical direction by the first guide roller 3, the third guide roller 5, the forth guide roller 6, and the fifth guide roller 7 that are engaged with the workpiece W from above and the sandwiching guide roller 9 to be engaged with the workpiece W from an oblique lower part. Accordingly, it is prevented that the adhesive tape applicator A floats from the workpiece W.

At the same time, due to a lateral directional component of an elastic sandwiching force from the oblique direction of the sandwiching guide roller 9, the tape applicator A is also prevented from wobbling in a lateral direction for the workpiece W. As a result, the tape applicator A can be moved at a stable posture for the workpiece W.

When the tape applicator A is lead to a curved portion x of the workpiece W shown in FIG. 1, the sandwiching guide roller 9 slightly releases engagement from the workpiece W once. After that, the sandwiching guide roller 9 is engaged again with the workpiece W on a middle position of the curved portion x to swingably guide the main body 1 supported by this region. Then, changing the posture while moving forward the tape applicator A, the tape applicator A continuously tales a posture along a liner or a substantially linear tape applying path. At this posture, firmly engaging the sandwiching guide roller 9 with the workpiece W again, tape applying will be continued.

Further, the tape portion overflowing up and down of the tape application face S is tangled in the upper and lower end portions of the inner frame portion w1 in after treatment and this realizes an appearance that is equivalent to coating processing.

### Second Embodiment

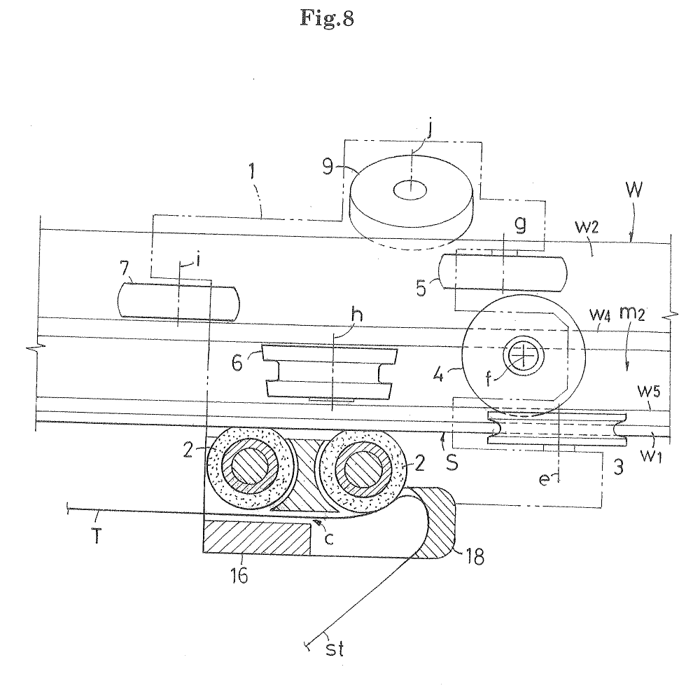

FIG. 8 shows a second embodiment of an adhesive tape applicator A according to the present invention. This adhesive tape applicator A is formed by simplifying the above-described first embodiment. Specifically, the tape feed roller 14 according to the first embodiment is omitted. In place of it, the adhesive tape T fed to the tape insertion gap c formed between the application rollers 2 and the tape guide 16 is winded and guided directly to the front application roller 2 to be introduced to the tape application face S, and the separated separator is guided to a lateral outside by the separator guide 18.

### Third Embodiment

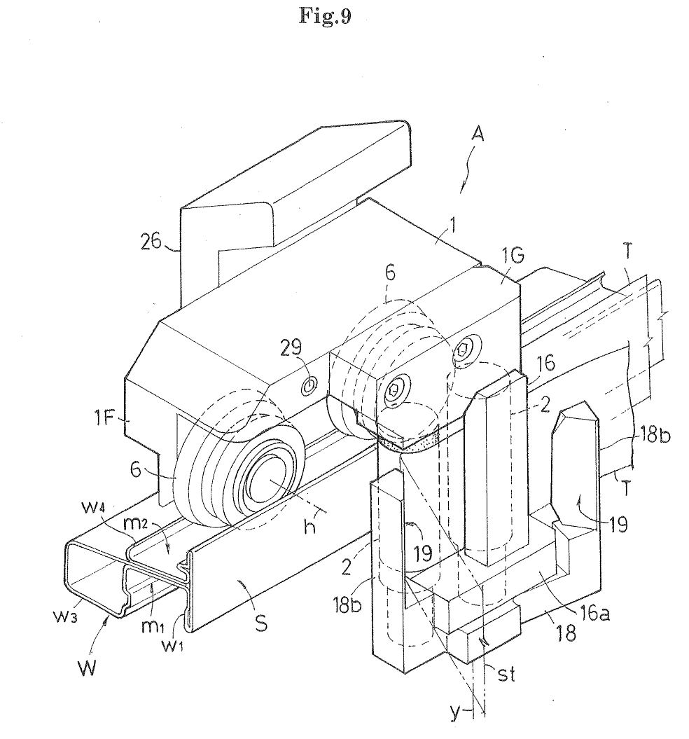

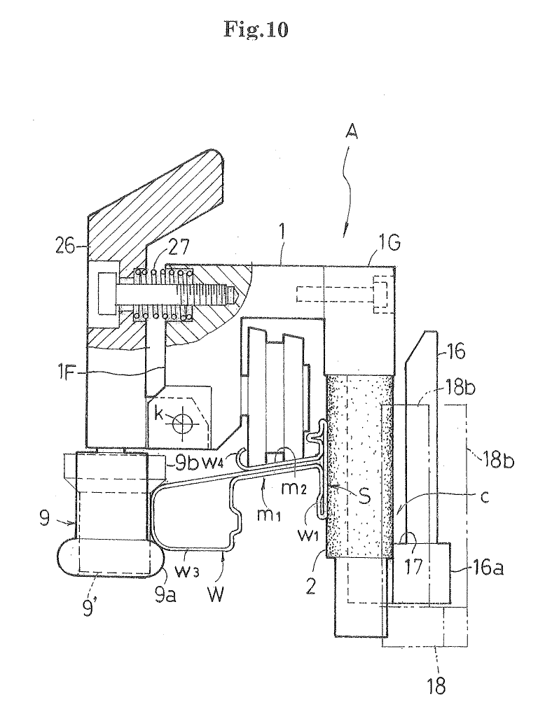

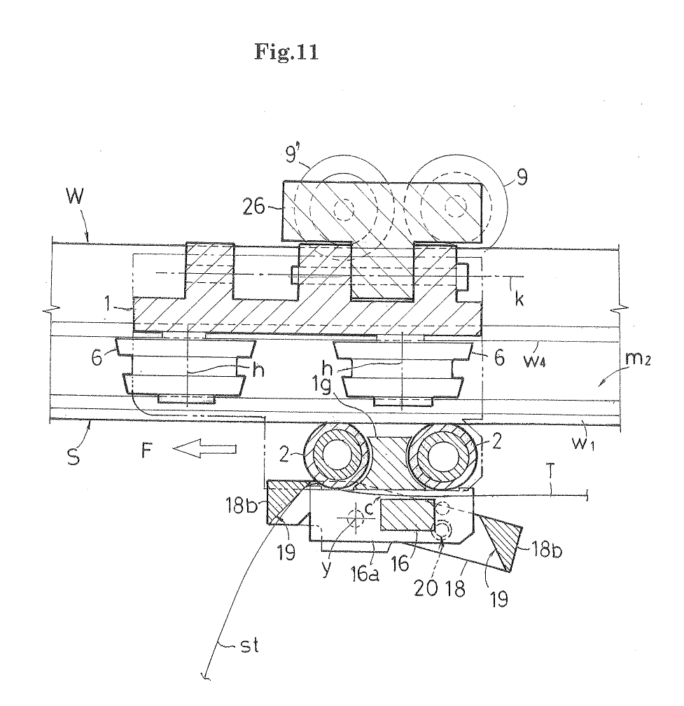

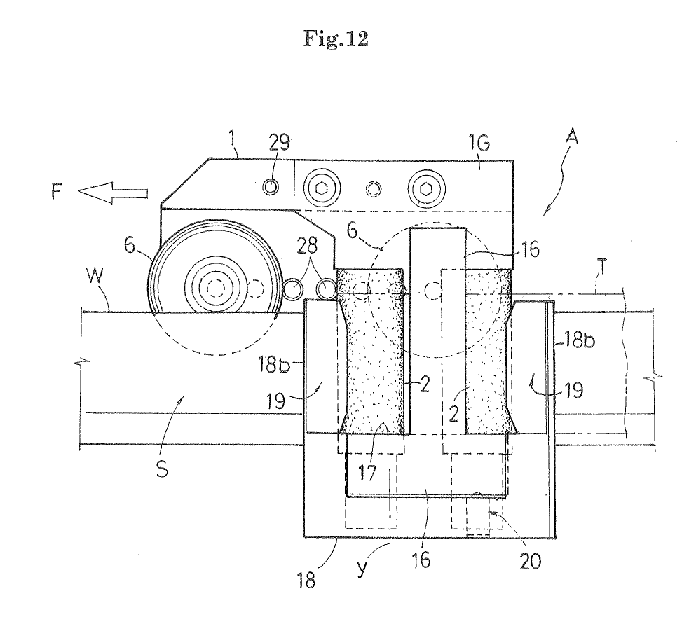

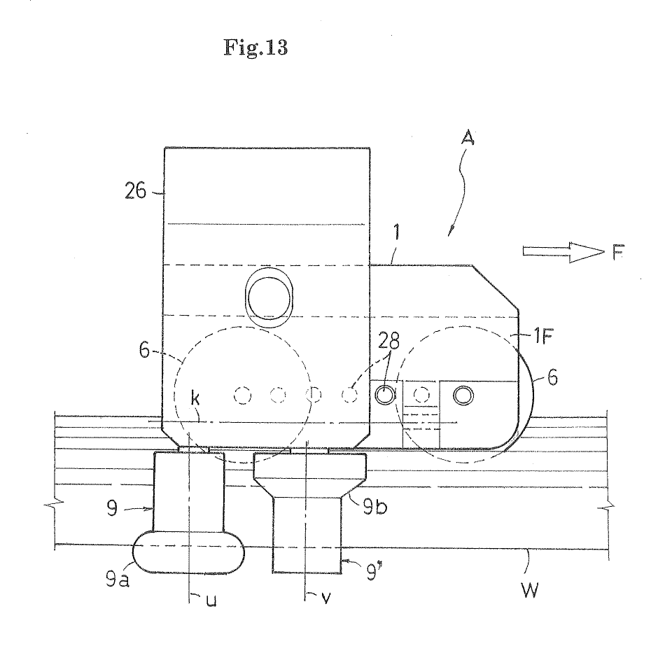

FIGS. 9 to 13 show an adhesive tape applicator A according to a third embedment. FIG. 9 is a perspective view showing the state that the adhesive tape applicator A is mounted on the workpiece W, FIG. 10 is a front view thereof, FIG. 11 is a cross sectional plan view thereof, FIG. 12 is a side view thereof, and FIG. 13 is a side view seeing FIG. 12 from the opposite side.

The main body 1 of the adhesive tape applicator A according to this embodiment is formed in an inversed L in a front vision. On the inside face of its longitudinal wall portion 1F, a pair of back and front guide rollers 6 rolling along the upper face of the workpiece engaged with a weather strip mounting groove m2 is mounted around a lateral axial core h so as to be capable of idling. In addition, on the lower face of the support shaft portion 1G connected to one end portion of the main body 1 by a bolt, a pair of back and forth application rollers 2 is supported so as to be capable of idling. Further, on the lower end face of a swinging lever portion 26 pivotally fitted centering around a forward axial core k on the lower part of the longitudinal wall portion 1F of the main body 1 shown in FIG. 10 and FIG. 11, a pair of back and forth sandwiching guide rollers 9 and 9′ is supported around longitudinal axial cores u and v so as to be capable of idling.

As shown in FIG. 10, the swinging lever portion 26 is swingably biased to the lateral outside by a compression coil spring 27. In other words, the first and second sandwiching guide rollers 9 and 9′ arranged on the lower end portion of the swinging lever portion 26 are biased inwardly. Due to this bias force, the workpiece W is elastically sandwiched between these sandwiching guide rollers 9 and 9′ and the application rollers 2.

Here, the first sandwiching guide roller 9 has the lower end portion that bulges in a circular shape. A circular large diameter part 9a thereof abuts against the curved angular portion on the lower part of the outer end of the hollow portion w3 of the workpiece W, so that the sandwiching guide roller 9 elastically presses the workpiece W obliquely upward. This makes it possible that the workpiece W is elastically sandwiched in a vertical direction by the guide roller 6 to be engaged with the workpiece W from above and the sandwiching guide roller 9 to be engaged with the workpiece W from obliquely beneath. Accordingly, it is prevented that the adhesive tape applicator A floats from the workpiece W.

On the other hand, the second sandwiching guide roller 9′ has the upper end portion that bulges in a trapezoidal shape. A straight tubular portion thereof abuts against the outer end portion of the hollow portion w3 of the workpiece W and a circular large diameter part 9b abuts against the curved angular portion on the upper part of the outer end of the hollow portion w3. This makes it possible to prevent the adhesive tape applicator A from wobbling with respect to the workpiece W in lateral and vertical directions.

As shown in FIG. 11, from the lower end of the support shaft portion 1G provided with the application rollers 2, a support part 1g is elongated downward between the application rollers 2. On the lower end portion of this support part 1g, the tape guide 16 is formed, and between the application rollers 2 and the tape guide 16, the tape insertion gap c is formed.

The upper face of the base portion 16a of the tape guide 16 is formed on the tape positing part 17 for accepting and mounting the lower end side of the adhesive tape T. In addition, on the lower face of the tape guide base portion 16a, the separator guide 18 is pivotally fitted around a longitudinal axial core y so as to be capable of swinging.

On the back and forth opposite end portions of the separator guide 18, the separator guide portion 18b having a triangle cross section is formed, and the separator guide portion 18b located on a front part in a applying direction is swung so as to approach the outer circumference of the front application roller 2. This makes it possible to guide the separator st separated from the adhesive tape T to a lateral outside by the inclined separator guide face 19 of the separator guide portion 18b.

Upon loading the adhesive tape T, the separator guide 18 is slightly swung. By doing so, the back and forth separator guide portions 18b is separated from the outer circumferential faces of the back and forth application rollers 2, and the adhesive tape T is wound around the front application roller 2 so that the separator st is separated to the outside. After that, the separator guide 18 is swung into a predetermined guide posture such that the front separator guide portion 18b is in proximity to the outer circumferential face of the front application roller 2.

The adhesive tape applicator A according to this embodiment can be also mounted on the workpiece W with the tape applying direction directed inversely. In this case, the separator guide 18 is swung in an inverse direction so that the separator guide portion 18b approaches the application roller 2 in front of the applying direction.

Then, on the opposed region between the separator guide 18 and the tape guide base portion 16a, the ball detent mechanism 20 is arranged, so that it is possible to stably hold the separator guide 18 in response to the tape applying direction by swingably switching the separator guide 18 into the above-described two guide postures.

Further, on the inside face of the longitudinal wall portion 1F of the main body 1, as shown in FIG. 12, a plurality of guide roller shaft support holes 28 is arranged back and forth. These guide roller shaft support holes 28 can change the position where the guide roller 6 is mounted back and forth in response to the kinds of the workpiece w and change of the tape applying direction. In addition, also on the end portion of the main body 1, a plurality of attaching holes 29 of the support shaft portion 1G is arranged back and forth and the locations of the application rollers 2 can be changed back and forth in response to the kinds of the workpiece w and change of the tape applying direction. Further, changing the locations of the swinging lever portions 26, the swinging lever portions 26 can be pivotally fitted to two places, namely, back and forth places for the main body 1, so that the locations of the sandwiching guide rollers 9 and 9′ can be changed back and forth in response to the kinds of the workpiece w and change of the tape applying direction.

Further, the separator guide 18 according to the present embodiment also can be applied to the configuration shown in the first embodiment.

In this case, the tape feed roller 14 may be provided back and forth of the application roller 2.

The present invention is not limited to the above-described embodiments but the present invention can be also practiced in the following forms.
(1) According to the above-described first and second embodiments, arrangement and the number of the guide rollers 3 to 7 to be engaged with the upper faces of the inner frame portion w1 of the workpiece W and the lateral frame portion w2 can be arbitrarily changed and determined depending on the shape of the workpiece.
(2) According to the above-described first and second embodiments, the sandwiching guide roller 9 is configured so as to be a grooved roller of which outer circumference is concave-curved. In other words, the sandwiching guide roller 9 may be configured so that a groove is guided and engaged to an angular part of the hollow portion w3 of the workpiece W. According to this configuration, a running and guiding function of the adhesive tape applicator A is made higher.
(3) According to the above-described first and second embodiments, the sandwiching guide roller 9 is arranged so as to be capable of vertically moving so as to be engaged with the lower face of the hollow portion w3 of the workpiece W and the sandwiching guide roller 9 can be effected while being biased upward by a spring.
(4) According to the above-described first and second embodiments, the sandwiching guide roller 9 is arranged with its position fixed and the sandwiching guide roller 9 is configured by a rubber roller having an appropriate elasticity so as to practice an elastic sandwiching force.
(5) According to the second embodiment, the diameter of the application roller 2 on the front side in a progress direction of the applicator is made larger than that of the application roller 2 on the rear side. In other words, the application rollers 2 are configured so as to be opposed in proximity to the end portion of the inside of the tape guide 16. According to this configuration, due to a difference of rotations of the tape feed rollers 14 and the application rollers 2, it is possible to remove the slack of the adhesive tape T just before being fed to the tape application face S.

The present invention may be embodied in other specific forms without departing from the spirit or essential attributes thereof and, accordingly, reference should be made to the appended claims, rather than to the foregoing specification, as indicating the scope of the invention.

What is claimed is:

1. An adhesive tape applicator for applying an adhesive tape that is formed in a curved shape corresponding to curving of a tape application face on a workpiece having a tape application face oriented toward a lateral side curved along a face direction thereof, comprising:
a guide roller for engaging the workpiece from above so as to roll around on a main body which is operated in moving along the workpiece; and
a first sandwiching guide roller for engaging the workpiece from below so as to sandwich the workpiece in a vertical direction in cooperation with the guide roller;
wherein the main body is configured to be held in engagement at a predetermined posture with respect to the workpiece with both the guide roller and the first sandwiching guide roller;
the applicator comprising;
an application roller for elastically pressing to apply an adhesive tape fed to the main body on a tape application face of the workpiece; and
a separation-prevention tape guide for preventing the adhesive tape from being separated from the application roller;
wherein the applicator has a tape positioning part for releasing an upper end in a tape width direction of a tape insertion gap to be formed by the tape guide and receiving and guiding a lower side edge of the adhesive tape on a lower end of the tape insertion gap.

2. The adhesive tape applicator according to claim 1, wherein
the first sandwiching roller is configured so as to be engaged with the outside face of the workpiece obliquely from a lower part of the workpiece.

3. The adhesive tape applicator according to claim 2, wherein
the first sandwiching roller has a groove, formed on a rolling face, for placing and fastening an angular portion of the workpiece.

4. The adhesive tape applicator according to claim 1, comprising: a spring for fixing a position of the guide roller and biasing the first sandwiching roller toward the side of the workpiece.

5. The adhesive tape applicator according to claim 1, comprising:
a second sandwiching roller rolling on the outside face of the workpiece opposite the tape application face.

6. The adhesive tape applicator according to claim 1, comprising:
a pair of upper and lower tape fastening grooves for temporarily fastening the end sides on the upper and lower sides of the adhesive tape to be winded and guided along a application roller and be introduced backward by inserting the upper and lower sides of the adhesive tape from the side into a rear place of the application roller.

7. The adhesive tape applicator according to claim 6, comprising:
a gage member for indicating a applying start end to be opposed to an end portion of the adhesive tape that is temporarily fastened to the tape fastening groove on a rear part of the main body.

8. The adhesive tape applicator according to claim 1, wherein
the adhesive tape is provided with a separator; the applicator comprising;
a separator guide for guiding the separator that is separated from the adhesive tape in a direction different from the adhesive tape, which is opposed in proximity to the application roller in a front position of the application roller.

9. The adhesive tape applicator according to claim 8, wherein
the separator guide is raised and swung to be opposed in proximity to the application roller and is swingably configured so as to turn over perpendicular to a position for guiding the separator in a lateral outside.

10. The adhesive tape applicator according to claim 8, comprising:
the separator guide on the opposite ends of the tape guide base portion that is axially-supported on the lower face of the tape guide;
wherein, when one separator guide swings the tape guide base portion around an axis so as to be opposed in proximity to the application roller on a front position in a progress direction, the separator guide located on a rear position of other application roller is configured so as to be moved away from the application roller.

11. The adhesive tape applicator according to claim 10, comprising:
a ball detent mechanism on a portion where the separator guide is opposed to the tape guide base portion.

12. The adhesive tape applicator according to claim 1, comprising:
a tape feed roller for winding and guiding the adhesive tape that is positioned by the tape positioning part so as to be lead to the application roller.

13. The adhesive tape applicator according to claim 12, wherein
the adhesive tape is provided with a separator; and the applicator comprising;
a separator guide for guiding the separator that is separated from the adhesive tape in a direction different from the adhesive tape, which is opposed in proximity to the application roller in a front position of the tape feed roller.

14. The adhesive tape applicator according to claim 13, wherein
the separator guide is raised and swung to be opposed in proximity to the application roller and is swingably configured so as to turn over perpendicular to a position for guiding the separator in a lateral outside.

15. The adhesive tape applicator according to claim 13, comprising:
the separator guide on the opposite ends of the tape guide base portion that is axially-supported on the lower face of the tape guide;
wherein, when one separator guide swings the tape guide base portion around an axis so as to be opposed in proximity to the application roller on a front position in a progress direction, the separator guide located on a rear position of other application roller is configured so as to be moved away from the application roller.

16. The adhesive tape applicator according to claim 15, comprising:
a ball detent mechanism on a portion where the separator guide is opposed to the tape guide base portion.
